(19) United States
(12) Patent Application Publication
(10) Pub. No.: US 2022/0325017 A1
(43) Pub. Date: Oct. 13, 2022

(54) METHOD FOR IMPROVING THE STORAGE STABILITY AND/OR TRANSPORT STABILITY OF A POLYMER

(71) Applicant: BOREALIS AG, Vienna (AT)

(72) Inventors: Jari-Jussi RUSKEENIEMI, Porvoo (FI); Jeroen ODERKERK, Stenungsund (SE); Juha HARTIKAINEN, Porvoo (FI); Tanja PIEL, Linz (AT); Daniela MILEVA, Linz (AT); Oscar PRIETO, Stunungsund (SE); Stefan HELLSTROEM, Stunungsund (SE)

(21) Appl. No.: 17/640,445

(22) PCT Filed: Sep. 2, 2020
(86) PCT No.: PCT/EP2020/074381

§ 371 Date: Mar. 4, 2022

(30) Foreign Application Priority Data
Sep. 6, 2019 (EP) 19195784.4

(51) Int. Cl. C08F 210/02; C08L 23/08; C08L 51/06; C08F 230/08; C08K 5/14; C08K 5/5419; C08K 5/134; C08J 3/24

(52) U.S. Cl. CPC C08F 210/02; C08L 23/0815; C08L 51/06; C08F 230/085; C08K 5/14; C08K 5/5419; C08K 5/134; C08J 3/24; C08J 2300/108

(57) ABSTRACT

The present invention refers to a method for improving the storage stability and/or transport stability of polymer (A) comprising the following steps: a) providing polymer (A) selected from the group consisting of copolymers of ethylene and a C₄C₁₂ alpha olefin comonomer, copolymers of propylene and mixtures thereof containing additionally comonomer units comprising hydrolysable silane groups; b) providing a stabilizer (B) selected from the group consisting of sterically hindered phenols, alkyltri-alkoxysilanes, alkenyltrialkoxysilanes and mixtures thereof; c) mixing polymer (A) and stabilizer (B) to obtain a stabilized polymer composition (I); and d) transferring the stabilized polymer composition (I) obtained in step c) in a container comprising at least one barrier layer. In addition, the present invention relates to the use of stabilizer (B) for improving the storage stability and/or transport stability of polymer (A) stored and/or transported in a container having a barrier layer.

The present invention relates to a method for improving the storage stability and/or transport stability of polymers comprising hydrolysable silane groups. In addition, the present invention refers to the use of specific stabilizers for improving the storage stability and/or transport stability of these polymers in a container having a barrier layer.

Polymers containing hydrolysable silane groups are needed in a wide range of applications, including cable jacketing, soles of shoes and sealing materials. The hydrolysable silane groups allow to crosslink the polymer and to change its properties significantly. Often the crosslinking is not carried out directly after production, but days or weeks later at a different location. Usually, crosslinking is initiated by a condensation catalyst, but slow crosslinking occurs without the addition of a catalyst and leads to unwanted increase in the melt viscosity and gel formation within the material limiting the time the material remains usable for further conversion. Therefore, it is necessary to prevent unwanted cross-linking after the production of the polymer.

Methods for surpressing unwanted cross-linking during and directly after the manufacturing of polymers comprising hydrolysable groups are already known in the art. WO 90/07542 A1 refers to a crosslinkable polymer composition comprising an olefin copolymer or graft copolymer with hydrolysable silane groups and a silanol condensation catalyst, as well as a silane compound with at least one hydrolysable organic group. The polymer composition is characterised in that the silane compound has a compatibility with the polymer composition of at least 0.035 mole hydrolysable groups per 100 g polymer composition, and in that the silane compound is represented by the general formula: R¹(SiR²ₙX₃₋ₙ)ₘ, wherein R¹ is a monofunctional hydrocarbyl group having 13 to 30 carbon atoms, or a difunctional hydrocarbyl group having 4 to 24 carbon atoms, R² is a hydrocarbyl group having 1 to 10 carbon atoms, X is a hydrolysable organic group, n is 0, 1 or 2, and m is 1 or 2.

EP 0 193 317 A2 relates to a silane-crosslinkable copolymer composition comprising (A) 100 parts by weight of a copolymer prepared by radically polymerizing a polymerizable monomeric mixture consisting essentially of ethylene and an ethylenically unsaturated silane compound having a hydrolyzable organic group under a high pressure, and (B) from 0.001 to 10 parts by weight of a silanol condensation catalyst, characterised in that said unsaturated silane compound is present in an amount of from 0.1 to 5.

The known methods making use of specific stabilizers are not suited for long term stabilization and there is still need for methods allowing to stabilize polymers comprising hydrolysable groups over a long period of time.

It was the objective of the present invention to provide a method that allows to store and/or transport polymers comprising hydrolysable silane groups.

This object has been solved by the method for improving the storage stability and/or transport stability of polymer (A) according to claim 1 of the present invention comprising at least the following steps:
a) providing polymer (A) selected from the group consisting of copolymers of ethylene and a C₄ to C₁₂ alpha olefin comonomer, copolymers of propylene and mixtures thereof containing additionally comonomer units comprising hydrolysable silane groups;
b) providing a stabilizer (B) selected from the group consisting of sterically hindered phenols, alkyltrialkoxysilanes, alkenyltrialkoxysilanes and mixtures thereof;
c) mixing polymer (A) and stabilizer (B) to obtain a stabilized polymer composition (I); and
d) transferring the stabilized polymer composition (I) obtained in step c) in a container comprising at least one barrier layer.

Surprisingly it was found that the specific combination of two stabilizing measures according to claim 1, namely a barrier layer and a stabilizer, allows an efficient long-term stabilization of the polymer.

Advantageous embodiments of the method in accordance with the present invention are specified in the dependent claims 2 to 13.

Claim 14 of the present invention relates to the use of a stabilizer (B) selected from the group consisting of sterically hindered phenols, alkyltrimethoxysilanes, alkenyltrimethoxysilanes and mixtures thereof for improving the storage stability and/or transport stability of a polymer (A) selected from the group consisting of copolymers of ethylene and a C₄ to C₁₂ alpha olefin comonomer, copolymers of propylene and mixtures thereof containing additionally comonomer units comprising hydrolysable silane groups, whereby the transport or storage of polymer (A) is conducted in a container having at least one barrier layer against moisture.

Claims 15 and 16 specify preferred embodiments of the use according to the present invention.

### DEFINITONS

The polymer compositions in accordance with the present invention comprise the components (A) (=polymer) and (B) (=stabilizer) and optionally other components, for example polymers different from component (A), additives, fillers or reinforcing agents. The requirement applies here that the components (A) and (B) and if present the other components add up to 100 wt.-% in sum. The fixed ranges of the indications of quantity for the individual components (A) and (B) and optionally the other components are to be understood such that an arbitrary quantity for each of the individual components can be selected within the specified ranges provided that the strict provision is satisfied that the sum of all the components (A) and (B) and optionally the further components add up to 100 wt.-%. In addition, it is preferred that components (A) and (B) form at least 50 wt.-%, more preferably at least 90 wt.-% of the polymer composition.

For the purposes of the present description and of the subsequent claims, a barrier layer is a layer building a barrier against moisture and preferably also against oxygen, preferably not more than 10 ppm and more preferably from 0 to 5 ppm water and/or oxygen can diffuse through the barrier layer.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### METHOD

In the following preferred embodiments of the method according to the present invention will be discussed.

One preferred embodiment of the method according to the present invention stipulates that the container in step d) is selected from the group consisting of sacks, bags, big bags, boxes, octabins, barrels, buckets, canisters and cans and preferably is a bag.

Preferably step d) of the method according to the present invention is conducted before the transport and/or storage of polymer composition (I).

The barrier layer of the container can be made of any material that has barrier effects against moisture and preferably also against oxygen. According to a preferred embodiment of the method according to the present invention the at least one barrier layer of the container comprises and preferably consists of a material selected from the group consisting of metal, preferably aluminium or vacuum-metallized polyester, HDPE, ethylene-vinyl alcohol, polyvinyl chloride, polyvinylidene chloride and mixtures thereof and more preferably consists of aluminium.

The barrier layer preferably has a thickness in the range of 1 to 300 μm and preferably from 5 to 200 μm.

In a further preferred embodiment of the method according to the present invention polymer (A) is a copolymer of ethylene and 1-octene having a density in the range of 850 kg/m³ to 920 kg/m³, preferably in the range of 850 to 880 kg/m³ and more preferably in the range of 855 to 870 kg/m³ measured according to ISO 1183.

Still another preferred embodiment of the method according to the present invention stipulates that polymer (A) is a a copolymer of ethylene and 1-octene and the base polymer without hydrolysable silane groups has a MFR₂ in the range of 0.1 to 20.0 g/10 min, preferably in the range of 0.1 to 5 g/10 min, more preferably in the range of 0.5 to 4.0 g/10 min and still more preferably in the range of 0.2 to 1.2 g/10 min measured according to ISO 1133 at 190° C. and a load of 2.16 kg.

According to another preferred embodiment of the method according to the present invention stipulates that polymer (A) is a a copolymer of ethylene and 1-octene and the polymer including hydrolysable silane groups has a MFR_{S} in the range of 0.1 to 30.0 g/10 min, preferably in the range of 0.1 to 20 g/10 min and more preferably in the range of 0.2 to 10 g/10 min measured according to ISO 1133 at 190° C. and a load of 5.0 kg.

According to a further preferred embodiment of the method according to the present invention the comonomer units comprising hydrolysable silane groups in polymer (A) are introduced by grafting or copolymerization and are preferably introduced by peroxide-initiated grafting.

In another preferred embodiment of the present invention the hydrolysable silane groups in polymer (A) originate from an alkenylalkoxysilane, preferably selected from the group consisting of vinyltrimethoxysilane, vinyltriethoxysilane, vinyltripropoxysilane, gamma-(meth)acryloxypropyl trimethoxysilane, gamma-(meth)acryloxypropyl triethoxysilane, and vinyl triacetoxysilane and mixtures thereof, wherein vinyltrimethoxysilane is most preferred. The skilled person is well aware that the starting materials used for introducing the hydrolysable silane groups in polymer (A) may at least partly change their structure during the incorporation into polymer (A). For example vinyltrimethoxysilane may be incorporated into polymer (A) by a radical process and the vinyl group is not present in the final polymer (A) any more.

According to a further preferred embodiment of the present invention stabilizer (B) is an alkyltrialkoxysilane represented by the general formula (1):

R¹(SiR²ₙX₃₋ₙ)ₘ (1)

wherein
R¹ is a monofunctional hydrocarbyl group having 2 to 30 carbon atoms, preferably 6 to 30 carbon atoms and more preferably 13 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2.

A particularly preferred stabilizer (B) is hexadecyltrimethoxysilane. One big advantage of said material is that it has a low vapour pressure and therefore does not disappear from the polymer composition due to evaporation.

Still another preferred embodiment of the present invention stipulates that stabilizer (B) is a sterically hindered phenol selected from the group consisting of pentaerythrityl-tetrakis(3-(3′,5′-di-tert. butyl-4-hydroxyphenyl)-propionate, octadecyl 3-(3′,5′-di-tert. butyl-4-hydroxyphenyl) propionate, 2,2′-thiodiethylenebis-(3,5-di-tert. butyl-4-hydroxyphenyl)-propionate, 1,3,5-Tris(3′,5′-di-tert. butyl-4′-hydroxybenzyl)-isocyanurate, 4,4′-Thiobis (2-tert. butyl-5-methylphenol) and mixtures thereof.

In a further preferred embodiment of the present invention the amount of the hydrolysable silane groups in polymer (A) is in the range of 0.5 to 5.0 wt.-%, preferably in the range of 0.5 to 3.0 wt.-%, more preferably in the range of 1.0 to 2.0 wt.-% and still more preferably in the range of 1.2 to 1.8 wt.-% based on the total weight of polymer (A). A lower amount of hydrolysable silane groups would make it difficult to achieve high crosslinking degree of the polymer and for a higher amount of hydrolysable silane groups it would be difficult to stabilize the polymer.

In still a further preferred embodiment of the present invention polymer composition (I) comprises 95.0 to 99.99 wt.-%, preferably 97.0 to 99.9 wt.-% of polymer (A) and 0.01 to 5.0 wt.-%, preferably 0.1 to 3.0 wt.-% of stabilizer (B); whereby polymer (A) and stabilizer (B) add up to 100 wt.-%.

A lower amount of stabilizer (B) would not allow to efficiently stabilize polymer (A) and a higher amount of the stabilizer would make it difficult to crosslink polymer (A).

According to a further preferred embodiment of the present invention polymer composition (I) comprises 97.0 to 99.5 wt.-%, preferably 98.0 to 99.5 wt.-% and more preferably 98.5 to 99.0 wt.-% polymer (A) and 0.5 to 3.0 wt.-%, preferably 0.5 to 2.0 wt.-% and more preferably 1.0 to 1.5 wt.-% of stabilizer B) being an alkyltrialkoxysilane represented by the general formula (1):

R¹(SiR²ₙX₃₋ₙ)ₘ (1)

wherein
R¹ is a monofunctional hydrocarbyl group having 2 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2;
and preferably stabilizer B) is hexadecyltrimethoxysilane; whereby polymer (A) and stabilizer (B) add up to 100 wt.-%.

Still a further preferred embodiment of the present invention stipulates that polymer composition (I) comprises 97.0 to 99.99 wt.-%, preferably 99.0 to 99.95 wt.-% and more preferably 99.50 to 99.90 wt.-% polymer (A) and 0.01 to 3.0 wt -%, preferably 0.05 to 1.0 wt.-% and more preferably 0.1 to 0.5 wt.-% of at least one sterically hindered phenol as stabilizer (B), preferably selected from the group consisting of pentaerythrityl-tetrakis(3-(3′,5′-di-tert. butyl-4-hydroxyphenyl)-propionate, octadecyl 3-(3′,5′-di-tert. butyl-4-hydroxyphenyl)propionate, 2,2′-thiodiethylenebis-(3,5-di-tert. butyl-4- hydroxyphenyl)-propionate, 1,3,5-Tris(3′,5′-di-tert. butyl-4′-hydroxybenzyl)-isocyanurate, 4,4′-Thiobis (2-tert. butyl-5-methylphenol) and mixtures thereof; whereby polymer (A) and stabilizer (B) add up to 100 wt.-%.

According to a further preferred embodiment of the present invention polymer (A) is grafted with a compound having hydrolysable silane groups and step c) is conducted before/during or after the grafting step, preferably step c) is conducted on an extruder during the grafting step.

Another preferred embodiment of the present invention stipulates that the MFR₅ measured according to ISO 1133 at 190° C. and a load of 5.00 kg of polymer composition (I) after 60 days storage and/or transport is not more than 25%, preferably not more than 15% and more preferably between 0.01 and 10% lower or from 0.01 to 30% higher than the MFR₅ measured according to ISO 1133 at 190° C. and a load of 5.00 kg of the same polymer composition (I) before the storage or transport.

According to another preferred embodiment of the present invention the MFR₅ measured according to ISO 1133 at 190° C. and a load of 5.00 kg of polymer composition (I) after 120 days storage and/or transport is not more than 50%, preferably not more than 40% and more preferably between 1 and 40% lower than the MFR₅ measured according to ISO 1133 at 190° C. and a load of 5.00 kg of the same polymer composition (I) before the storage or transport.

A preferred polymer composition (I) comprises and preferably is consisting of: 97.0 to 99.5 wt.-% based on the overall weight of polymer composition (I) of polymer (A) being a copolymer of ethylene and 1-octene grafted with vinyltrimethoxysilane, having a density in the range of 850 kg/m³ to 920 kg/m³, measured according to ISO 1183, a MFR₂ in the range of 0.1 to 20.0 g/10 min, measured according to ISO 1133 at 190° C. and a load of 2.16 kg; and

0.50 to 3.0 wt.-% based on the overall weight of polymer composition (I) of stabilizer (B) being selected from the group consisting of hexadecyltrimethoxysilane, pentaerythrityl-tetrakis(3-(3′,5′-di-tert. butyl-4-hydroxyphenyl)-propionate, octadecyl 3-(3′,5′-di-tert. butyl-4-hydroxyphenyl)propionate and mixtures thereof;
wherein polymer (A) and stabilizer (B) add up to 100 wt.-%; and wherein the container has a barrier layer against moisture made of aluminium.

### USE

The present invention also refers to the use of a stabilizer (B) selected from the group consisting of sterically hindered phenols, alkyltrimethoxysilanes, alkenyltrimethoxysilanes and mixtures thereof for improving the storage stability and/or transport stability of a polymer (A) selected from the group consisting of copolymers of ethylene and a C₄ to C₁₂ alpha olefin comonomer, copolymers of propylene and mixtures thereof containing additionally comonomer units comprising hydrolysable silane groups, whereby the transport and/or storage of polymer (A) is conducted in a container having at least one barrier layer.

According to a preferred embodiment of the use of the present invention 0.50 to 3.0 wt.-%, based on the overall weight of polymer (A) and stabilizer (B), of stabilizer (B) being a compound represented by the general formula (1):

R¹(SiR²ₙX₃₋ₙ)ₘ (1)

wherein
R¹ is a monofunctional hydrocarbyl group having 2 to 30 carbon atoms, 6 to 30 carbon atoms and more preferably 13 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2;
are used for improving the storage stability and/or transport stability of 97.0 to 99.5 wt.-%, based on the overall weight of polymer (A) and stabilizer (B), of polymer (A) being a copolymer of ethylene and 1-octene grafted with vinyltrimethoxysilane, having a density in the range of 850 kg/m³ to 920 kg/m³, measured according to ISO 1183, a MFR₂ in the range of 0.1 to 20.0 g/10 min, measured according to ISO 1133 at 190° C. and a load of 2.16 kg.

Still another preferred embodiment of the use of the present invention stipulates that stabilizer (B) is selected from the group consisting of hexadecyltrimethoxysilane, pentaerythrityl-tetrakis(3-(3′,5′-di-tert. butyl-4-hydroxyphenyl)-propionate, octadecyl 3-(3′,5′-di-tert. butyl-4-hydroxyphenyl)propionate and mixtures thereof.

According to another preferred embodiment of the use according to the present invention the barrier layer comprises or consists of a material selected from the group consisting of metal, preferably aluminium, HDPE, ethylene-vinyl alcohol, polyvinyl chloride, polyvinylidene chloride and mixtures thereof and more preferably consists of aluminium.

All preferred aspects and embodiments as described above for the method according to the present invention shall also hold for the use according to the present invention.

The invention will now be described with reference to the following non-limiting examples.

### EXPERIMENTAL PART

### A. Measuring Methods

The following definitions of terms and determination methods apply for the above general description of the invention as well as to the below examples unless otherwise defined.

### Melt Flow Rate (MFR)

MFR₅ was measured according to ISO 1133 at a load of 5.00 kg, at 190° C. for the PE copolymers.

MFR₂ is measured according to ISO 1133 ata load of 2.16 kg, at 190° C. for the PE copolymers.

### Density

Density of the materials was measured according to ISO 1183-1.

### Quantification of VTMS in PE-g-VTMS Copolymer

Quantitative nuclear-magnetic resonance (NMR) spectroscopy was used to quantify the VTMS content of the polymers.

Quantitative ¹H NMR spectra recorded in the molten-state using a Bruker Avance III 500 NMR spectrometer operating at 500.13 MHz. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification (see literature klimke06, parkinson07 and castignolles09 as specified below). Standard single-pulse excitation was employed applying short recycle delay of 2 s. A total of 128 transients were acquired per spectrum. Quantitative ¹H NMR spectra were processed, integrated and quantitative properties determined using custom spectral analysis automation programs. All chemical shifts are internally referenced to the polyethylene methylene signal at 1.33 ppm.

Characteristic signals resulting from grafting of vinyltrimethylsiloxane, in various comonomer sequences, were observed. The vinyltrimethylsiloxane grafting was quantified using the integral of the signal at 3.52 ppm assigned to the 1VTMS sites (see literature brandolini01), accounting for the number of reporting nuclei per comonomer:

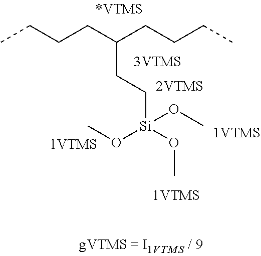

The ethylene content (E) was quantified using the integral of the bulk aliphatic (bulk) signal between 0.00 to 3.00 ppm. This integral must be compensated by subtracting 4 times gVTMS (2 methylene groups, 2VTMS and 3VTMS) and add once gVTMS (*VTMS missing 1 proton) in total subtracting 3 times gVTMS.

E=(bulk−3*gVTMS)/4

It should be noted that an insignificant error is introduced due to the inability to compensate for the saturated chain ends without associated branch sites.

The total mole fractions of vinyltrimethylsiloxane in the polymer was calculated as:

fVTMS=gVTMS/(E+gVTMS)

The total comonomer incorporations of vinyltrimethylsiloxane in weight percent was calculated from the mole fractions in the standard manner:

cVTMS[wt.-%]=[100*(fVTMS*148.23)]/[(fVTMS*148.23)+((1-fVTMS)*28.05)]

The quantification of grafted vinyltrimethylsiloxane in weight percent cVTMS [wt.-%] by ¹H

NMR as described is independent from additional alpha-co-olefins with even numbers of carbons e.g. C4, C6 or C8 which might be incorporated in the polyethylene chain.

### LITERATURE

brandolini01

A. J. Brandolini, D. D. Hills, “NMR spectra of polymers and polymer additives”, Marcel Deker Inc., 2000.

klimke06

Klimke, K., Parkinson, M., Piel, C., Kaminsky, W., Spiess, H. W., Wilhelm, M., Macromol. Chem. Phys. 2006; 207:382.

parkinson07

Parkinson, M., Klimke, K., Spiess, H. W., Wilhelm, M., Macromol. Chem. Phys. 2007; 208:2128.

castignolles09

Castignolles, P., Graf, R., Parkinson, M., Wilhelm, M., Gaborieau, M., Polymer 50 (2009) 2373.

### B. MATERIALS USED

Table 1 summarizes the materials used for manufacturing the polymer compositions.

TABLE 1
Starting materials.

| Material | Description | Manufacturer |
|---|---|---|
| Queo 6200-01 | Copolymer of ethylene and 1-octene | Borealis AG |
| | (MFR₂ = 0.5 g/10 min, density = 862 | |
| | kg/m³) | |
| Silfin 24 | Mixture of peroxide (POX) and | Evonik |
| | vinyltrimethoxsilane (VTMS) | |
| HDTMS | Hexadecyltrimethoxysilane | Evonik |
| AO | CAS-no. 6683-19-8, Pentaerythrityl- | BASF AG |
| | tetrakis(3-(3′,5′-di-tert. butyl-4- | |
| | hydroxyphenyl)-propionate, Tradename: | |
| | Irganox 1010 | |
| Ca-stearate | Calciumstearate | Baerlocher |
| LDPE bag | — | Roth (Carl Roth GmbH) |
| Aluminium | — | Eurostat group |
| lined bag | | |

### C. PREPARATION OF THE POLYMER COMPOSITIONS

The polymer compositions according to the inventive examples (IE1 and 1E2) and the comparative examples (CE1 to CE3) were prepared by mixing and grafting Queo 6200-01 with the amounts of peroxide and VTMS as given in below Table 2 and reacting them in a co-rotation twin screw extruder (Werner & Pfleiderer ZSK 30) having a L/D of 38 with 12 barrels, at a temperature of 200° C. with a residence time of 60 seconds, to obtain grafted polymer (A). For IE1 and 1E2 additionally stabilizer (B) and for CE2 and CE3 calcium stearate has been added in the co-rotation twin screw extruder.

Table 2 summarizes the composition of the prepared polymer compositions comprising grafted polymer (A) and optionally stabilizer (B) or calcium stearate.

TABLE 2
Composition of the prepared polymer compositions.

| | | Stabilizer (B) or | VTMS | POX | | MFR₅ after |
|---|---|---|---|---|---|---|
| | | other additives | in feed | in feed | VTMS | grafting |
| No. | Polymer (A) | (amount in [wt.-%])* | [wt.-%] | [wt.-%] | [wt.-%]** | [g/ 10 min] |
| CE1 | Queo 6200-01 | — | 2.56 | 0.125 | 1.79 | 0.48 |
| CE2 | Queo 6200-01 | Ca-stearate (0.06) | 2.57 | 0.126 | 1.73 | 0.49 |
| CE3 | Queo 6200-01 | Ca-stearate (0.03) | 2.56 | 0.125 | 1.82 | 0.43 |
| IE1 | Queo 6200-01 | HDTMS (0.95) | 2.51 | 0.123 | 1.57*** | 0.49 |
| IE2 | Queo 6200-01 | AO1 (0.1) | 2.54 | 0.124 | 1.73 | 0.49 |

*based on the total amount of the polymer composition;
**based on the total amount of polymer (A);
***determined by NMR under the assumption that all added HDTMS is in the polymer composition, the amount of VTMS has been calculated based on the NMR-signal of the methoxy group (1.98 wt.-% (determined by NMR) − (0.95 wt.-% * 0.428 (ratio of mol. weights of VTMS to HDTMS)).

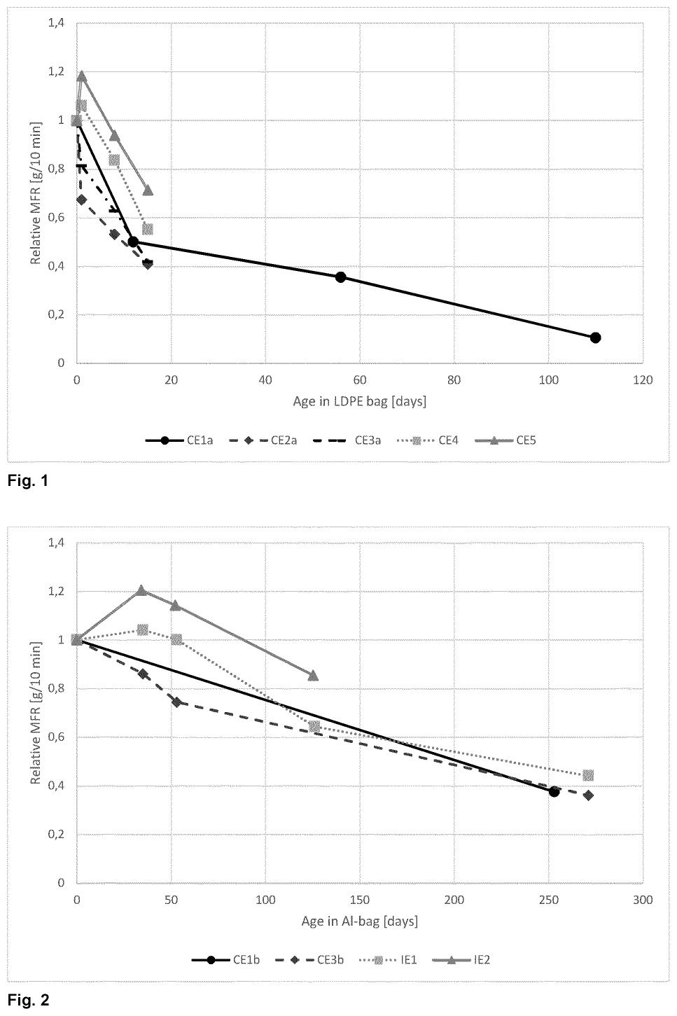

The ageing of the polymer compositions was studied by storing pellets of each polymer composition in a LDPE bag and in an aluminium lined bag, both bags have been opened to atmosphere when transferring the polymer into it. The MFR_{S} of the samples was measured after different storage times and the results are summarized in below Tables 3 and 4 and in FIGS. 1 and 2 (showing the relative MFR vs. time). For CE1a to CE3a and CE1b and CE3b the polymer compositions according to CE1 to CE3 or CE1 and CE3, respectively, were used.

TABLE 3
Summary of the ageing test in a LDPE bag.

| | | CE2a (ca- | CE3a (ca- | | |
|---|---|---|---|---|---|
| | CE1a (no | stearate, | stearate | CE4 | CE5 |
| MFR₅, time | additives) | 0.06 wt.-%) | 0.03 wt.-%) | (HDTMS)^{a} | (AO1)^{b} |
| MFR₅ [g/10 min], | 0.48 | 0.49 | 0.43 | 0.49 | 0.49 |
| 0 h | | | | | |
| MFR₅ [g/10 min], | n.m. | 0.33 (33) | 0.35 (19) | 0.52 | 0.58 |
| 1 day (loss in %) | | | | | |
| MFR₅ [g/10 min], | n.m. | 0.26 (47%) | 0.27 (37) | 0.41 (16) | 0.46 (6) |
| 8 days (loss in %) | | | | | |
| MFR₅ [g/10 min], | 0.24 (50) | n.m. | n.m. | n.m. | n.m. |
| 12 days (loss in %) | | | | | |
| MFR₅ [g/10 min], | — | 0.20 (59) | 0.18 (58) | 0.27 (45) | 0.35 (29) |
| 15 days (loss in %) | | | | | |
| MFR₅ [g/10 min], | 0.17 (65) | n.m. | n.m. | n.m. | n.m. |
| 56 days loss in %) | | | | | |
| MFR₅ [g/10 min], | <0.10 (>80) | n.m. | n.m. | n.m. | n.m. |
| 110 days (loss in %) | | | | | |

^{a}pellets made of polymer composition IE1 according to Table 2 were used;
^{b}pellets made of polymer composition IE2 according to Table 2 were used;
n.m. = not measured.

TABLE 4
Summary of the ageing test in an Aluminium-lined bag.

| | | CE3b (ca- | | |
|---|---|---|---|---|
| | CE1b (no | stearate, | IE1 | IE2 |
| MFR₅, time | additives) | 0.03 wt.-%) | (HDTMS) | (AO1) |
| MFR₅ | 0.48 | 0.43 | 0.49 | 0.49 |
| [g/10 min], 0 h | | | | |
| MFR₅ [g/10 min], | n.m. | 0.37 (14) | 0.51 | 0.59 |
| 35 days (loss in %) | | | | |
| MFR₅ [g/10 min], | n.m. | 0.32 (26) | 0.49 | 0.56 |
| 53 days (loss in %) | | | | |
| MFR₅ [g/10 min], | n.m. | n.m. | 0.32 (35) | 0.42 (14) |
| 125 days | | | | |
| MFR₅ [g/10 min], | 0.18 (63) | n.m. | n.m. | n.m. |
| 253 days (loss in %) | | | | |
| MFR₅ [g/10 min], | n.m. | 0.16 (63) | 0.22 (55) | n.m. |
| 271 days (loss in %) | | | | |

n.m. = not measured.

### D. DISCUSSION OF THE RESULTS

For the samples according to CE1a, CE2a and CE3a no stabilizing measures were used, whereas for the samples according to CE4 and CE5 a stabilizer was added. As can be gathered from Table 3 for the samples without any stabilizing measures the MFR₅ drops to below 50% of the original value after only 15 days. Addition of the stabilizer allows for the use of the material for at least to 8 days with minimal decrease in MFR (<16%) after being removed from barrier bag/exposed to atmosphere as the stabilizer slows the initial MFR drop. The MFR of the stabilized composition does however keep dropping, which means that the mere addition of a stabilizer is not sufficient for the long-term stabilization of the polymer.

For the samples according to CE1b and CE2b a barrier layer was used as stabilizing measure and the samples according to the invention IE1 and IE2 were stabilized with a barrier layer and a stabilizer. As can be seen from Table 4 the MFR₅ of the inventive is quite stable after more than 50 days. The MFR₅ of the Comparative Examples CE1 and CE3 starts to decrease after 35 days and after 253 days a value of below 60% of the original value was measured. For the samples according to the invention IE1 and IE2 the MFR₅ is still on an acceptable level after 125 days and even after more than 250 days a MFR₅ of around 50% of the original value is measured.

To sum it up, only the specific combination of the two stabilizing measures according to claim 1, namely a barrier layer and a stabilizer, allows an efficient long-term stabilization of the polymer. The method according to the present invention also allows to extend the handling time, this means the time after the material has been removed from the container with barrier layer and exposed to the atmosphere.

1. A method for improving the storage stability and/or transport stability of polymer (A) comprising the following steps:
a) providing polymer (A) selected from the group consisting of copolymers of ethylene and a C₄ to C₁₂ alpha olefin comonomer, copolymers of propylene and mixtures thereof containing additionally comonomer units comprising hydrolysable silane groups;
b) providing a stabilizer (B) selected from the group consisting of sterically hindered phenols, alkyltrialkoxysilanes, alkenyltrialkoxysilanes and mixtures thereof;
c) mixing polymer (A) and stabilizer (B) to obtain a stabilized polymer composition (I); and
d) transferring the stabilized polymer composition (I) obtained in step c) in a container comprising at least one barrier layer.

2. The method according to claim 1, characterized in that,
the container is selected from the group consisting of sacks, bags, big bags, boxes, octabins, barrels, buckets, canisters and cans and preferably is a bag.

3. The method according to claim 1 or 2, characterized in that,
the at least one barrier layer of the container comprises and preferably consists of a material selected from the group consisting of metal, preferably aluminium or vacuum-metallized polyester, HDPE, ethylene-vinyl alcohol, polyvinyl chloride, polyvinylidene chloride and mixtures thereof and more preferably consists of aluminium.

4. The method according to any one of the preceding claims, characterized in that,
polymer (A) is a copolymer of ethylene and 1-octene, having a density in the range of 850 kg/m³ to 920 kg/m³, preferably in the range of 850 to 880 kg/m³ and more preferably in the range of 855 to 870 kg/m³ measured according to ISO 1183; preferably polymer (A) including hydrolysable silane groups has a MFR_{S} in the range of 0.1 to 30.0 g/10 min, preferably in the range of 0.1 to 20 g/10 min and more preferably in the range of 0.2 to 10 g/10 min measured according to ISO 1133 at 190° C. and a load of 5.0 kg; and/or
the bases polymer for polymer (A) without hydrolysable silane groups has a MFR₂ in the range of 0.1 to 20.0 g/10 min, preferably in the range of 0.1 to 5 g/10 min, more preferably in the range of 0.5 to 4 g/10 min and more preferably in the range of 0.2 to 1.2 g/10 min measured according to ISO 1133 at 190° C. and a load of 2.16 kg.

5. The method according to any one of the preceding claims, characterized in that,
the comonomer units comprising hydrolysable silane groups in polymer (A) are introduced by grafting or copolymerization and are preferably introduced by peroxide-initiated grafting; and/or
the hydrolysable silane groups in polymer (A) originate from an alkenylalkoxysilane, preferably selected from the group consisting of vinyltrimethoxysilane, vinyltriethoxysilane, vinyltripropoxysilane, gamma-(meth)acryloxypropyl trimethoxysilane, gamma-(meth)acryloxypropyl triethoxysilane, and vinyl triacetoxysilane and mixtures thereof, wherein vinyltrimethoxysilane is most preferred.

6. The method according to any one of the preceding claims, characterized in that,
stabilizer (B) is an alkyltrialkoxysilane represented by the general formula (1):
R¹(SiR²ₙX₃₋ₙ)ₘ (1)
wherein
R¹ is a monofunctional hydrocarbyl group having 2 to 30 carbon atoms, preferably 6 to 30 carbon atoms and more preferably 13 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2;
more preferably stabilizer (B) is hexadecyltrimethoxysilane; and/or
stabilizer (B) is a sterically hindered phenol selected from the group consisting of pentaerythrityl-tetrakis(3-(3′,5′-di-tert. butyl-4-hydroxyphenyl)-propionate, octadecyl 3-(3′, 5′-di-tert. butyl-4-hydroxyphenyl)propionate, 2,2′-thiodiethylenebis-(3,5-di-tert. butyl-4-hydroxyphenyl)-propionate, 1,3,5-Tris(3′,5′-di-tert. butyl-4′-hydroxybenzyl)-isocyanurate, 4,4′-Thiobis (2-tert. butyl-5-methylphenol) and mixtures thereof.

7. The method according to any one of the preceding claims, characterized in that,
the amount of the hydrolysable silane groups in polymer (A) is in the range of 0.5 to 5.0 wt.-%, preferably in the range of 0.5 to 3.0 wt.-%, more preferably in the range of 1.0 to 2.0 wt.-% and still more preferably in the range of 1.2 to 1.8 wt.-% based on the total weight of polymer (A).

8. The method according to any one of the preceding claims, characterized in that,
polymer composition (I) comprises
95.0 to 99.99 wt.-%, preferably 97.0 to 99.9 wt.-% of polymer (A); and
0.01 to 5.0 wt.-%, preferably 0.1 to 3.0 wt.-% of stabilizer (B); whereby
polymer (A) and stabilizer (B) add up to 100 wt.-%.

9. The method according to any one of the preceding claims, characterized in that,
polymer composition (I) comprises
97. 0 to 99.5 wt.-%, preferably 98.0 to 99.5 wt.-% and more preferably 98.5 to 99.0 wt.-% polymer (A); and
0.5 to 3.0 wt.-%, preferably 0.5 to 2.0 wt.-% and more preferably 1.0 to 1.5 wt.-% of stabilizer B) being an alkyltrialkoxysilane represented by the general formula (1):
R¹(SiR²ₙX₃₋ₙ)ₘ (1)
wherein
R¹ is a monofunctional hydrocarbyl group having 2 to 30 and preferably 13 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2;
and preferably stabilizer B) is hexadecyltrimethoxysilane; whereby
polymer (A) and stabilizer (B) add up to 100 wt.-%.

10. The method according to any one of the preceding claims, characterized in that,
polymer composition (I) comprises
97.0 to 99.99 wt.-%, preferably 99.0 to 99.95 wt.-% and more preferably 99.50 to 99.90 wt.-% polymer (A); and
0.01 to 3.0 wt-%, preferably 0.05 to 1.0 wt.-% and more preferably 0.1 to 0.5 wt.-% of at least one sterically hindered phenol as stabilizer (B), preferably selected from the group consisting of pentaerythrityl-tetrakis(3-(3′,5′-di-tert. butyl-4-hydroxyphenyl)-propionate, octadecyl 3-(3′,5′-di-tert. butyl-4-hydroxyphenyl)propionate, 2,2′-thiodiethylenebis-(3,5-di-tert. butyl-4-hydroxyphenyl)-propionate, 1,3,5-Tris(3′,5′-di-tert. butyl-4′-hydroxybenzyl)-isocyanurate, 4,4′-Thiobis (2-tert. butyl-5-methylphenol) and mixtures thereof; whereby
polymer (A) and stabilizer (B) add up to 100 wt.-%.

11. The method according to any one of the preceding claims, characterized in that,
polymer (A) is grafted with a compound having hydrolysable silane groups and step c) is conducted before/during or after the grafting step, preferably step c) is conducted on an extruder during the grafting step.

12. The method according to any one of the preceding claims, characterized in that,
the MFR₅ measured according to ISO 1133 at 190° C. and a load of 5.00 kg of polymer composition (I) after 60 days storage and/or transport is not more than 25%, preferably not more than 15% and more preferably between 0.01 and 10% lower or from 0.01 to 30% higher than the MFR₅ measured according to ISO 1133 at 190° C. and a load of 5.00 kg of the same polymer composition (I) before the storage or transport; and/or
the MFR₅ measured according to ISO 1133 at 190° C. and a load of 5.00 kg of polymer composition (I) after 120 days storage and/or transport is not more than 50%, preferably not more than 40% and more preferably between 1 and 40% lower than the MFR₅ measured according to ISO 1133 at 190° C. and a load of 5.00 kg of the same polymer composition (I) before the storage or transport.

13. The method according to any one of the preceding claims, characterized in that,
polymer composition (I) comprises and preferably is consisting of:
97.0 to 99.5 wt.-% based on the overall weight of polymer composition (I) of polymer (A) being a copolymer of ethylene and 1-octene grafted with vinyltrimethoxysilane, having a density in the range of 850 kg/m³ to 920 kg/m³, measured according to ISO 1183, a MFR₂ in the range of 0.1 to 20.0 g/10 min, measured according to ISO 1133 at 190° C. and a load of 2.16 kg; and
0.50 to 3.0 wt.-% based on the overall weight of polymer composition (I) of stabilizer (B) being selected from the group consisting of hexadecyltrimethoxysilane, pentaerythrityl-tetrakis(3-(3′,5′-di-tert. butyl-4-hydroxyphenyl)-propionate, octadecyl 3-(3′,5′-di-tert. butyl-4-hydroxyphenyl)propionate, 2,2′-thiodiethylenebis-(3,5-di-tert. butyl-4-hydroxyphenyl)-propionate, 1,3,5-Tris(3′,5′-di-tert. butyl-4′-hydroxybenzyl)-isocyanurate, 4,4′-Thiobis (2-tert. butyl-5-methylphenol) and mixtures thereof;
wherein polymer (A) and stabilizer (B) add up to 100 wt.-%; and wherein
the container has a barrier layer against moisture made of aluminium.

14. Use of a stabilizer (B) selected from the group consisting of sterically hindered phenols, alkyltrimethoxysilanes, alkenyltrimethoxysilanes and mixtures thereof for improving the storage stability and/or transport stability of a polymer (A) selected from the group consisting of copolymers of ethylene and a C₄ to C₁₂ alpha olefin comonomer, copolymers of propylene and mixtures thereof containing additionally comonomer units comprising hydrolysable silane groups, whereby the transport and/or storage of polymer (A) is conducted in a container having at least one barrier layer.

15. Use according to claim 14, characterized in that,
0.50 to 3.0 wt.-%, based on the overall weight of polymer (A) and stabilizer (B), of stabilizer (B) being a compound represented by the general formula (1):
R¹(SiR²ₙX₃₋ₙ)ₘ (1)
wherein
R¹ is a monofunctional hydrocarbyl group having 2 to 30 carbon atoms, 6 to 30 carbon atoms and more preferably 13 to 30 carbon atoms or a difunctional hydrocarbyl group having 4 to 24 carbon atoms and preferably is a hexadecyl group;
R² may be same or different and is a hydrocarbyl group having 1 to 10 carbon atoms;
X may be same or different and is an alkoxy group, preferably is the same alkoxy group and more preferably is the same and methoxy;
n is 0, 1 or 2, and preferably is 0;
m is 1 or 2;
and is preferably selected from the group consisting of hexadecyltrimethoxysilane, pentaerythrityl-tetrakis(3-(3′,5′-di-tert. butyl-4-hydroxyphenyl)-propionate, octadecyl 3-(3′, 5′-di-tert. butyl-4-hydroxyphenyl)propionate and mixtures thereof; are used for improving the storage stability and/or transport stability of
97.0 to 99.5 wt.-%, based on the overall weight of polymer (A) and stabilizer (B), of polymer (A) being a copolymer of ethylene and 1-octene grafted with vinyltrimethoxysilane, having a density in the range of 850 kg/m³ to 920 kg/m³, measured according to ISO 1183, a MFR₂ in the range of 0.1 to 20.0 g/10 min, measured according to ISO 1133 at 190° C. and a load of 2.16 kg.
